(19) United States
(12) Patent Application Publication
(10) Pub. No.: US 2004/0185719 A1
(43) Pub. Date: Sep. 23, 2004

(54) Signal adaptor for USB and PS/2 connector

(76) Inventor: Yung-Hui Wang, Taipei City (TW)

Correspondence Address: BIRCH STEWART KOLASCH & BIRCH, PO BOX 747, FALLS CHURCH, VA, 22040-0747, US

(21) Appl. No.: 10/749,407

(22) Filed: Jan. 2, 2004

(30) Foreign Application Priority Data
Mar. 18, 2003 (TW) 092204150

(51) Int. Cl. H01R 25/00

(52) U.S. Cl. 439/638

(57) ABSTRACT

A structure of a signal adaptor is disclosed. The base of the signal adaptor of the present invention has a USB adaptor and a PS/2 adaptor set on two sides providing a user a choice for fitting a variety of connectors for data transmission.

### BACKGROUND OF THE INVENTION

1. The field of the invention

The present invention generally relates to a signal adaptor, and more particularly to a signal adaptor for USB and PS/2 connectors providing a user a choice to select either a USB adaptor and/or a PS/2 adaptor for the signal transmission.

2. Description of Related Art

The rapid advancement in computer technology has led to the development of computers with powerful calculation, faster processing speed, and upgrade capabilities. The data transmission between the computer and the peripheral device depends on a connecting wire. Nowadays the keyboard and the mouse of the computer are usually designed to use the PS/2 interface. The adaptor of the PS/2 interface is smaller than the conventional one, and the space occupation of the PS/2 adaptor is less, and therefore the mouse will occupy negligible space on the corn port. However, for effectively increasing the transmission speed of the peripheral device, the peripheral device interface of the new generation is available as a universal serial bus (USB). The transmission speed of USB interface exists in two modes, namely, 1.5 Mbps and 12 Mbps, and such interface can connect to a maximum of 127 peripheral devices. The transmission speed of USB is faster than that of a parallel port or a serial port of a personal computer. Therefore, apparently, USB can be useful for upgrading the signal transmission of the computer and the peripheral interface. Furthermore, the USB interface commonly can also support almost all the peripheral devices, such as the network card, HUB, keyboard, mouse, joystick, CD ROM, tape drive, printer, scanner, digital camera and the like. The peripheral devices usually require a PS/ or USB adaptor for the signal transmission, and if the computer only has one type of the adaptor, the user needs to connect the other adaptor externally for switching the interface from a PS/2 to a USB and vice versa (shown as FIGS. 8 and 9). Nevertheless, the signal will become weaker as it transmits through the switching adaptor to the computer, and the weakened signal can cause error in computation while processing. Besides, the external adaptor is an additional cost to the user.

Accordingly, how to solve the above defects of the conventional design has become an important issue for the manufacturer in the field.

### SUMMARY OF THE INVENTION

Accordingly, in the view of the foregoing, the present inventor makes a detailed study of related art to evaluate and consider, and uses years of accumulated experience in this field, and through several experiments, to create a new signal adaptor to resolve the aforementioned defects of the prior art. The present invention provides an innovated cost effective signal adaptor for USB and PS/2 connectors providing a user to select either a USB adaptor and/or a PS/2 adaptor for signal transmission.

According to an aspect of the present invention, the signal adaptor has a base comprising a USB adaptor and a PS/2 adaptor set on two sides providing a user a choice for fitting a variety of connectors for data transmission.

### BRIEF DESCRIPTION OF THE DRAWING

For a more complete understanding of the present invention, reference will now be made to the following detailed description of preferred embodiments taken in conjunction with the following accompanying drawings.

FIG. 1 is the elevational view of a signal adaptor according to a preferred embodiment of the present invention.

FIG. 2 is the elevational view (I) showing an application of the signal adaptor according to a preferred embodiment of the present invention.

FIG. 3 is the elevational view (II) showing an application of the signal adaptor according to a preferred embodiment of the present invention.

FIG. 4 is the elevational view (I) of a signal adaptor according to a preferred embodiment of the present invention.

FIG. 5 is the elevational view (II) of a signal adaptor according to a preferred embodiment of the present invention.

FIG. 6 is the elevational view (III) of a signal adaptor according to a preferred embodiment of the present invention.

FIG. 7 is the elevational view (IV) of a signal adaptor according to a preferred embodiment of the present invention.

FIG. 8 is the elevational view (I) of a conventional signal adaptor.

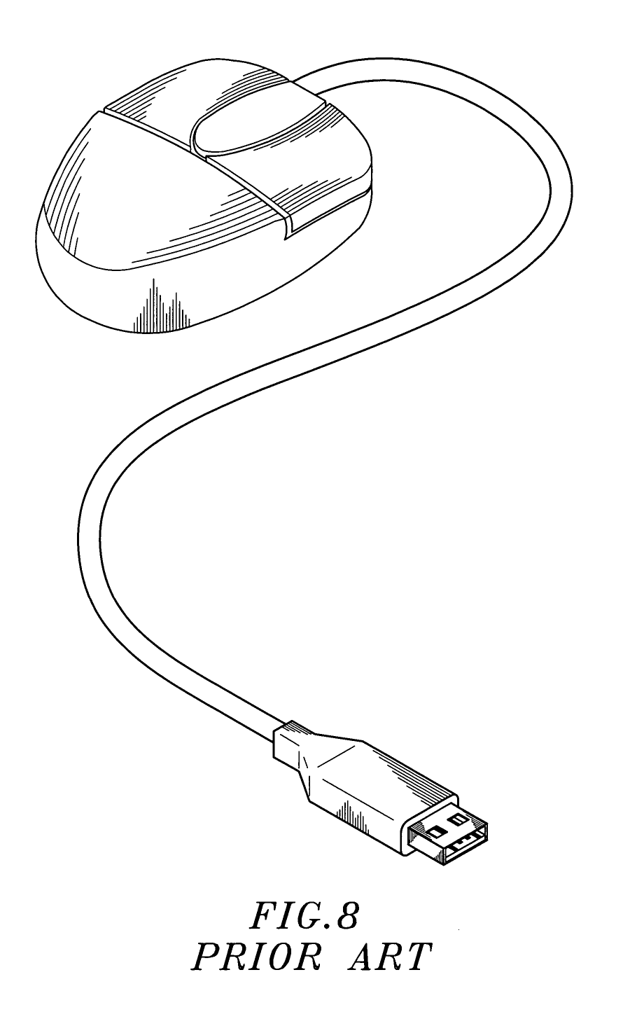

FIG. 9 is the elevational view (II) of a conventional signal adaptor.

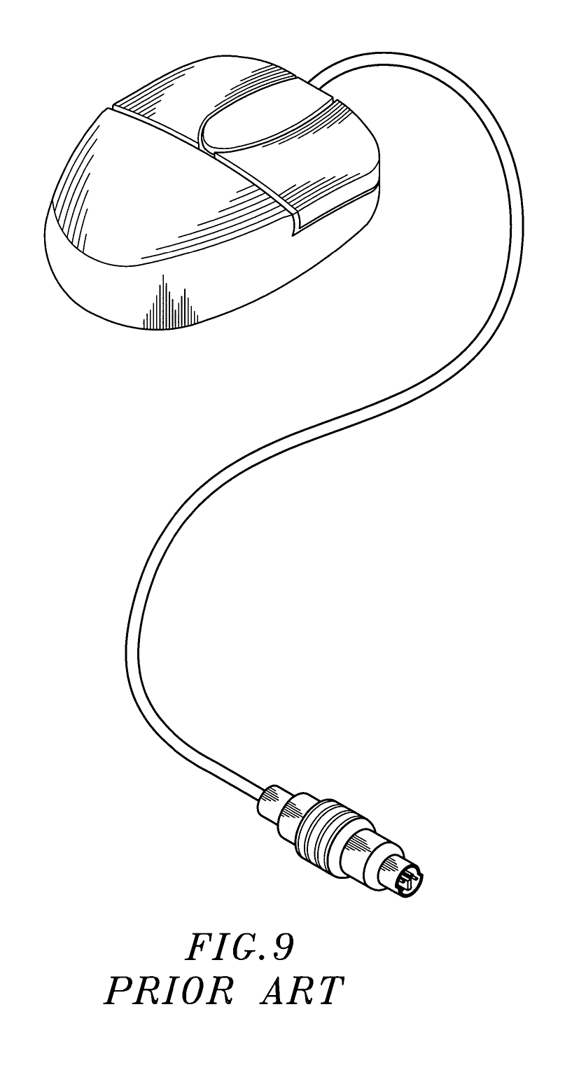

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

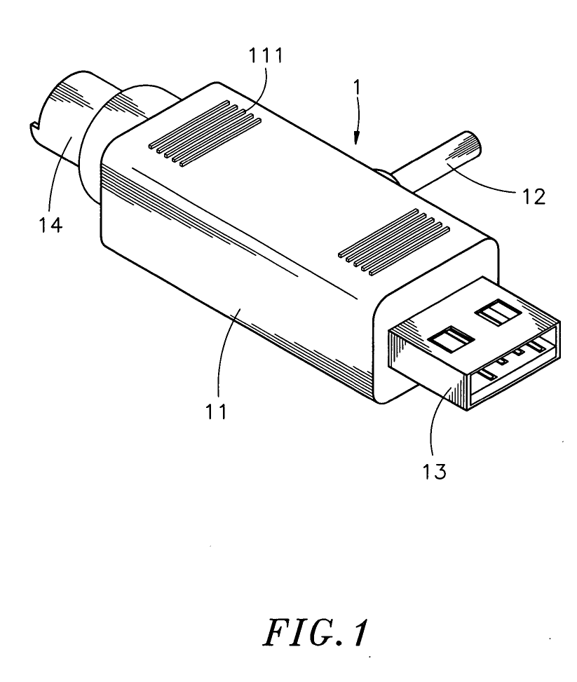

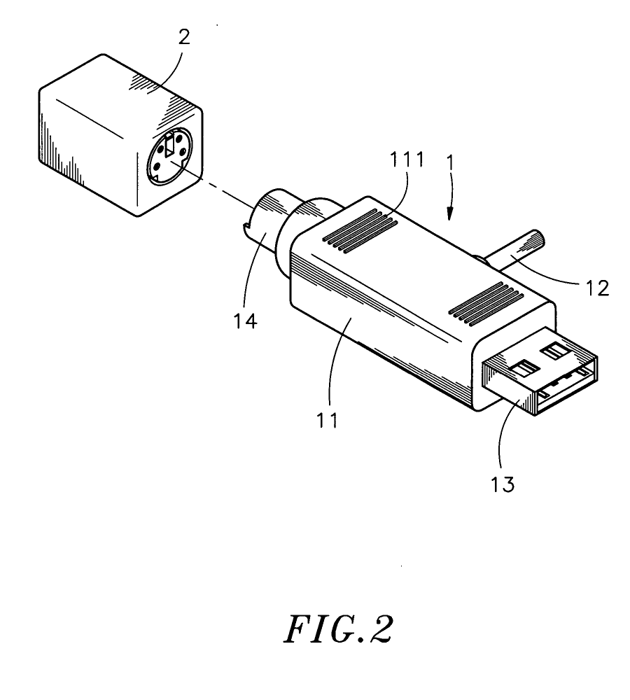

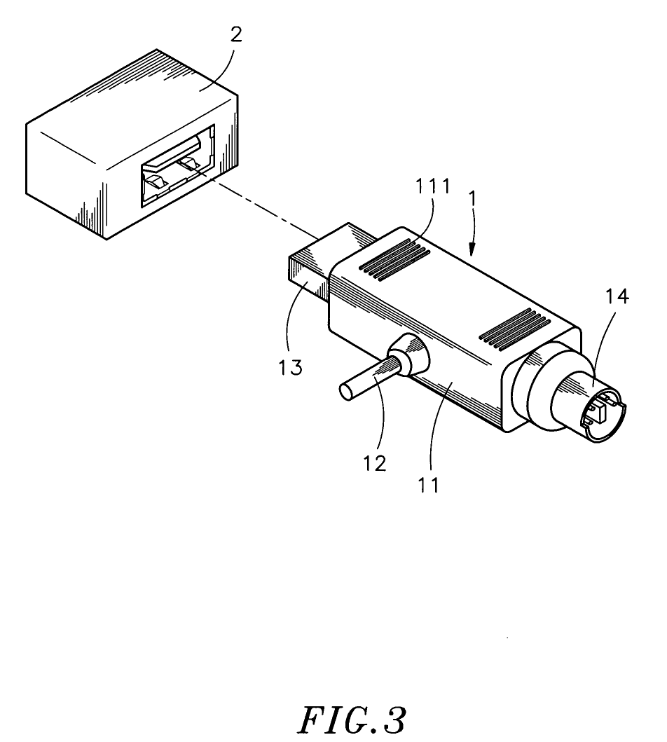

Referring to FIGS. 1, 2 and 3, an elevational view of a signal adaptor according to a preferred embodiment of the present invention, and an elevational view (I) and (II) showing an application of the signal adaptor according to a preferred embodiment of the present invention, are respectively shown. The signal adaptor 1 comprises an base 11 comprised of an insulation material is connected to a transmission wire 12. A USB adaptor 13 is set at one side of the base 11 and a PS/2 adaptor 14 is set at the other side thereof. A plurality of protrusions 111 is formed on a surface of the base 11 of the adaptor 1.

The above structure of the signal adaptor 1 provides a user to connect a connector 2 configured to either a USB adaptor 13 or a PS/2 adaptor 14.

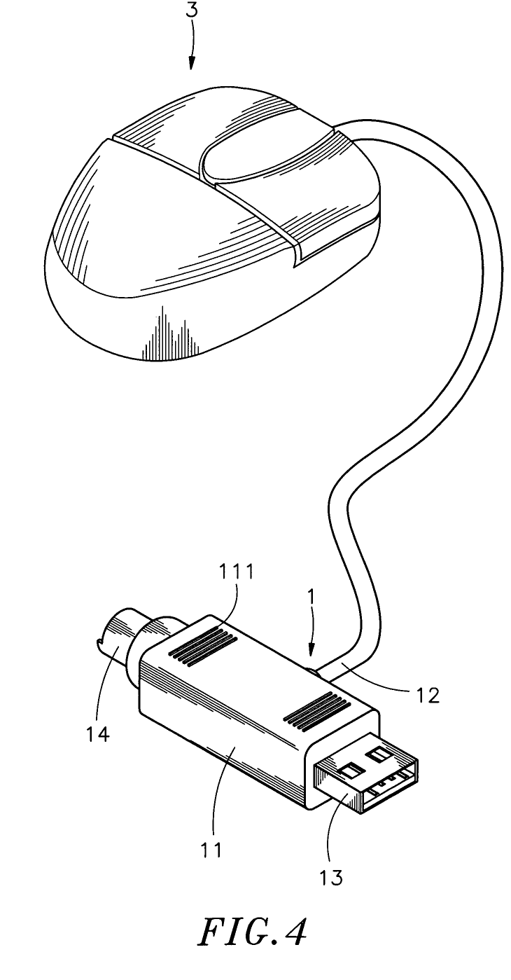

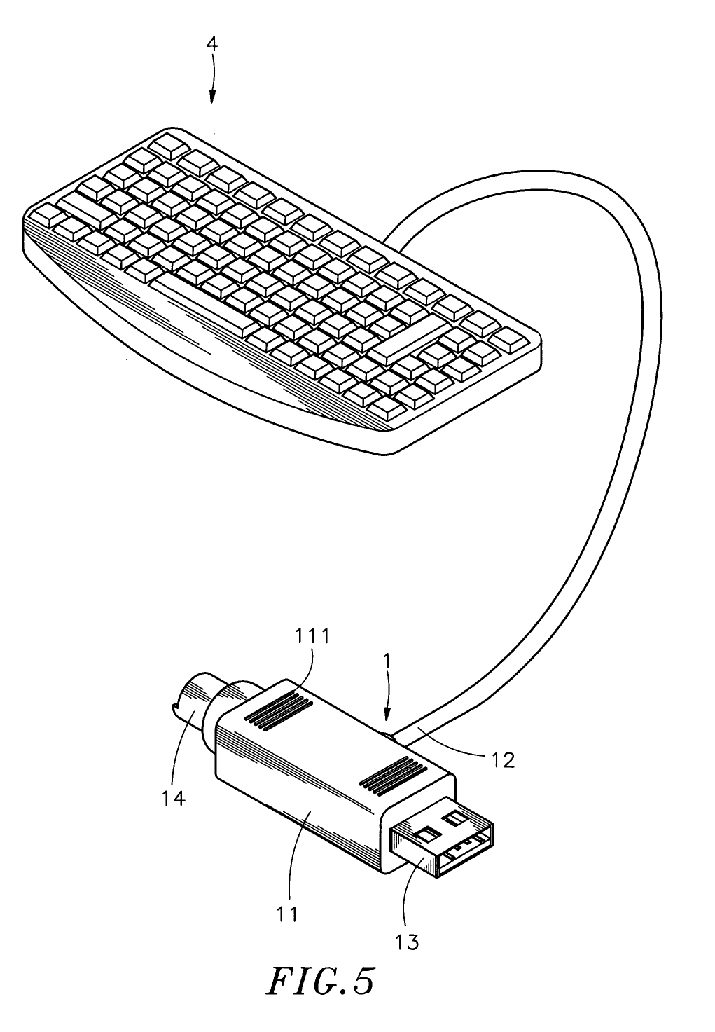

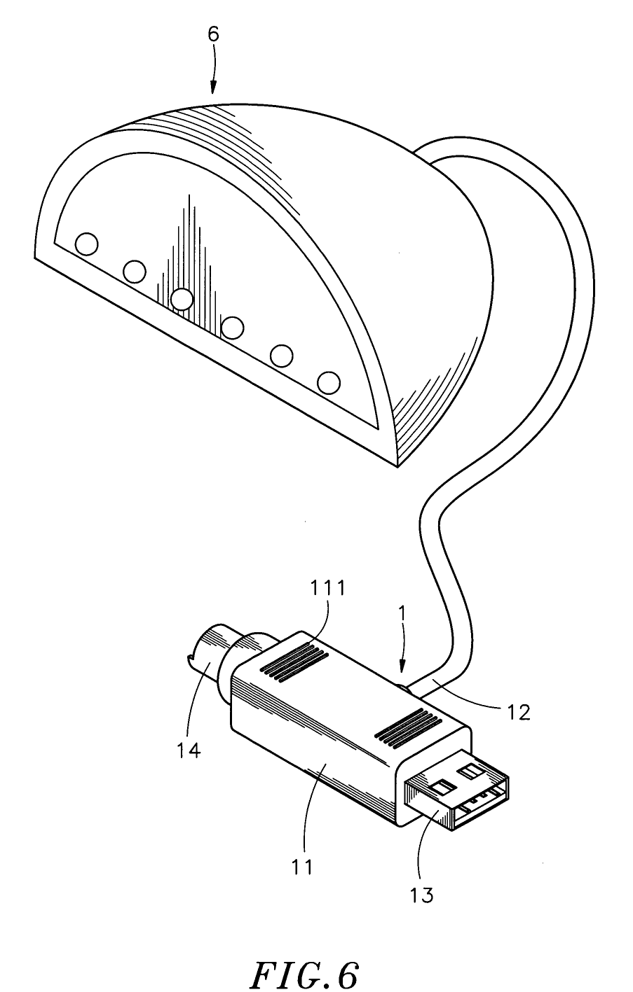

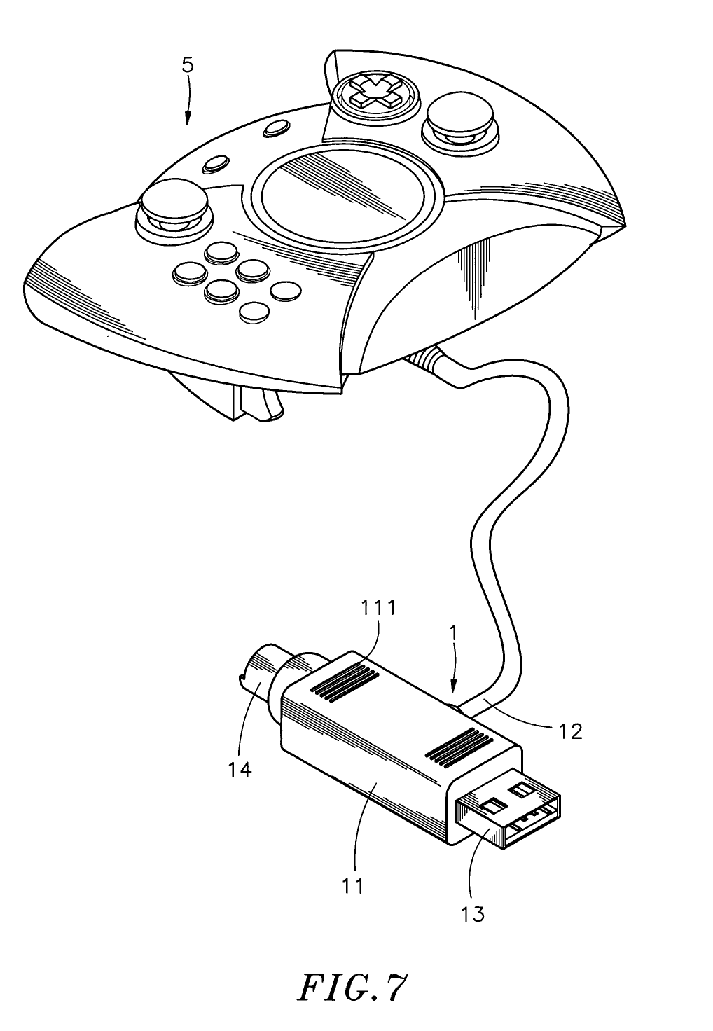

Referring to FIGS. 4, 5, 6 and 7, elevational views (I), (II), (III) and (IV) of a signal adaptor according to a preferred embodiment of the present invention are respectively shown. As shown, a distal end of the transmission wire 12 is connected to the base 11 of the adaptor 1 and a primal end thereof is connected to a mouse 3, a keyboard 4, a joystick 5 or a wireless receiver 6, allowing a user to select a variety of peripheral devices for processing signal transmission in a variety of modes.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A signal adaptor for a USB and a PS/2 connector, comprising:
a base, having a USB adaptor on one side and a PS/2 adaptor on another side thereof, wherein the base is connected to one end of a transmission wire, and wherein another end of the transmission wire can be connected to signal input device and a connector configured for connecting to a USB adaptor can be connected to the USB adaptor of the base or a connector configured for connecting to a PS/2 adaptor can be connected to the PS/2 adaptor of the base.

2. The signal adaptor for a USB and a PS/2 connector according to claim 1, wherein a plurality of protrusion is formed on a surface of said base.

3. The signal adaptor for a USB and a PS/2 connector according to claim 1, wherein said base of adaptor is comprised of an insulation material.

4. The signal adaptor for a USB and a PS/2 connector according to claim 1, wherein said signal input device is a mouse.

5. The signal adaptor for a USB and a PS/2 connector according to claim 1, wherein said signal input device is a keyboard.

6. The signal adaptor for a USB and a PS/2 connector according to claim 1, wherein said signal input device is a joystick.

7. The signal adaptor for ah USB and a PS/2 connector according to claim 1, wherein said signal input device is a wireless receiver.
